(19) United States
(12) Patent Application Publication
(10) Pub. No.: US 2024/0253574 A1
(43) Pub. Date: Aug. 1, 2024

(54) LOAD PLATFORM APPARATUSES AND SYSTEMS

(71) Applicant: Thule Sweden AB, Hillerstorp (SE)

(72) Inventors: Johan LARSSON, Jonkoping (SE); Magnus FERMAN, Varnamo (SE); Markus NORDANGÅRD, Varnamo (SE); Peter WIKSTRÖM, Skillingaryd (SE)

(21) Appl. No.: 18/426,168

(22) Filed: Jan. 29, 2024

Related U.S. Application Data
(60) Provisional application No. 63/482,499, filed on Jan. 31, 2023.

(51) Int. Cl. B60R 9/05

(52) U.S. Cl. CPC B60R 9/05

(57) ABSTRACT

A vehicle mounted roof rack includes a perimeter rail system and a plurality of load bars coupled to the perimeter rail system. The perimeter rail system includes a front rail, a rear rail, a first side rail, and a second side rail. The plurality of load bars can be disposed within an interior space of the perimeter rail system.

### BACKGROUND

### Field

The present disclosure relates to load platforms. More specifically, embodiments of the present disclosure relate to vehicle load platforms, for example, roof mounted cargo platforms and racks, with aerodynamic features.

### Background

Carrying loads on a vehicle roof expands the load carrying capacity of the vehicle beyond the available volume of the vehicle cabin. Examples of loads that can be carried on a vehicle roof include luggage, containers, bicycles, kayaks, rooftop tents, and cargo platforms. All of these loads need to be secured to the vehicle roof to prevent unwanted movement of the load, especially while the vehicle is moving. Loads are typically secured to the roof rails of a vehicle that run lengthwise along the vehicle roof. Cargo platforms are connected to and span the roof rails and provide multiple mounting points for multiple rooftop loads. Current cargo platforms often require complex assembly of platform accessories or have limited flexibility of moving or adjusting platform accessories such that they have limited functionality. In addition, current systems are often not compatible with all types of roof accessories such as larger roof boxes. There exists a need for improved accessory mounting systems for cargo platforms to increase flexibility of the accessories and improve versatility of the cargo platform to be compatible with more rooftop accessory products.

### BRIEF SUMMARY

Accordingly, there is a need to provide a cargo platform with improved mounting features for guard rail and fairing accessories, and to provide accessory load bars for mounting additional rooftop accessories to the cargo platform.

In some embodiments, a vehicle mounted roof rack includes a perimeter rail system and a plurality of load bars. In some embodiments, the perimeter rail system includes a front rail, a rear rail, a first side rail, and a second side rail. In some embodiments, the plurality of load bars can couple to the perimeter rail system and be disposed within an interior space of the perimeter rail system.

In some embodiments, the front rail includes a first cross-sectional shape along a midline of the perimeter rail system. In some embodiments, the rear rail includes a second cross-sectional shape along the midline of the perimeter rail system. In some embodiments, the first cross-sectional shape is different from the second cross-sectional shape. In some embodiments, the second cross-sectional shape tapers towards a rear edge of the rear rail.

In some embodiments, the perimeter rail system includes a front corner member coupled between the front rail and one of the first side rail and the second side rail. In some embodiments, the front corner member includes a top corner surface and a bottom corner surface. In some embodiments, the bottom corner surface is spaced from and non-parallel to the top corner surface. In some embodiments, a low point can be disposed on the bottom corner surface and spaced a first distance from the top corner surface. In some embodiments, the front rail can include a top surface and a bottom surface. In some embodiments, the bottom surface can be spaced from the top surface by a second distance. In some embodiments, the first distance is greater than the second distance. In some embodiments, the top corner surface of the front corner member is coplanar with the top surface of the front rail.

In some embodiments, at least one of the front rail, the first side rail, and the second side rail includes a bottom surface that defines a plane extending along the bottom surface. In some embodiments, the plane can intersect the front corner member between the top corner surface and the low point.

In some embodiments, a guard rail assembly for a vehicle mounted roof rack can include a guard rail. In some embodiments, the vehicle mounted roof rack can include a perimeter rail system having a rail with a channel formed in the rail. In some embodiments, the guard rail can include a main body portion and an assembly portion extending from the main body portion. In some embodiments, the assembly portion can be configured to be disposed in the channel of the rail.

In some embodiments, the assembly portion of the guard rail can include a tail and an arm extending from the tail. In some embodiments, the channel can include a groove formed in a bottom surface of the channel and an elongated notch. In some embodiments, when the guard rail is assembled in the channel, the arm of the assembly portion can be configured to be disposed in the elongated notch and the tail can be configured to extend into the groove.

In some embodiments, the guard rail can be coupled with a first side rail of the perimeter rail system and a second guard rail can be coupled with and a second side rail of the perimeter rail system. In some embodiments, a third guard rail can be coupled with a front rail and a fourth guard rail can be coupled with a rear rail of the perimeter rail system.

In some embodiments, a vehicle mounted roof rack can include a perimeter rail system, a plurality of load bards, and at least one guard rail. In some embodiments, the perimeter rail system can include a front rail, a rear rail, a first side rail, and a second side rail. In some embodiments, a first channel is formed in at least one of the front rail, the rear rail, the first side rail, and the second side rail. In some embodiments, the plurality of load bars can be coupled to the perimeter rail system and be disposed within an interior space of the perimeter rail system. In some embodiments, a second channel can be formed in at least one of the plurality of load bars. In some embodiments, the guard rail can include a main body portion and an assembly portion extending from the main body portion. In some embodiments, the assembly portion is configured to be disposed in the first channel.

In some embodiments, the first channel can have a first depth and the second channel can have a second depth. In some embodiments, the first depth can be greater than the second depth. In some embodiments, the assembly portion can have a first height. In some embodiments, the first height can be less than the first depth and greater than the second depth such that the guard rail cannot be assembled on the plurality of load bars.

In some embodiments, a guard rail can include a main body portion and an assembly portion, a vehicle mounted roof rack can include a perimeter rail system and a channel formed in a rail of the perimeter rail system, and a method of assembling the guard rail to the vehicle mounted roof rack can include the steps of arranging the assembly portion of the guard rail adjacent to the channel formed in the rail of the perimeter rail system; arranging the guard rail at a first angle; inserting a tail of the assembly portion of the guard rail into the channel; rotating the guard rail to a second angle such that an arm extending from the tail of the assembly portion extends into an elongated notch of the channel to couple the guard rail to the vehicle mounted roof rack.

In some embodiments, a fairing for a vehicle load rack can include a coupling portion and a blade. In some embodiments, the coupling portion can be configured to couple to the vehicle load rack. In some embodiments, the blade can extend from the coupling portion at an oblique angle.

In some embodiments, the coupling portion can include a plurality of slots formed in the coupling portion for adjustably coupling the fairing to the vehicle load rack. In some embodiments, the blade can include a body and a bumper coupled to a perimeter of the body. In some embodiments, a plurality of slots can be formed along the perimeter of the body of the blade. In some embodiments, the bumper can include an assembly slot and an assembly tab extending into the assembly slot. In some embodiments, the assembly tab can be configured to engage a slot in the body of the blade to couple the bumper to the body of the blade.

In some embodiments, the body of the blade can be substantially flat. In some embodiments, a lower edge of the body of the blade can be concave. In some embodiments, a plurality of channels can be formed in a forward side of the coupling portion and the blade and configured to stiffen the fairing.

In some embodiments, the blade can extend at a first angle relative to the coupling portion. In some embodiments, the first angle can be between about 5 degrees and about 45 degrees. In some embodiments, the first angle can be about 25 degrees. In some embodiments, the fairing can be configured to rotate relative to the coupling member to adjust the first angle.

In some embodiments, an accessory mount can be configured to couple to a vehicle mounted roof rack. In some embodiments, the vehicle mounted roof rack can have a perimeter rail system and a load bar coupled to the perimeter rail system. In some embodiments, the accessory mount can include an accessory beam, a first mounting base, and a second mounting base. In some embodiments, the first mounting base can be disposed at a first end of the accessory beam. In some embodiments, the second mounting base can be disposed at a second end of the accessory beam. In some embodiments, the first and second mounting bases can be configured to couple to the load bar and elevate the accessory beam above the load bar and the perimeter rail system.

In some embodiments, the first mounting base can include a connecting portion and a foot portion. In some embodiments, the connecting portion can include an end wall and an arm extending opposite the end wall and into a recess formed in the accessory beam. In some embodiments, the foot portion can extend from the connecting portion and be disposed between the accessory beam and the load bar.

In some embodiments, the accessory mount can further include an assembly bolt. In some embodiments, the assembly bolt can be configured to couple the accessory mount to the load bar. In some embodiments, the assembly bolt can extend through a first aperture formed in the accessory beam and a second aperture formed in the first mounting base. In some embodiments, a channel can be formed in the load bar along the length of the load bar. In some embodiments, the assembly bolt can couple with an anchor slidably disposed in the channel.

In some embodiments, the recess of the accessory beam can include a mount recess and a side recess. In some embodiments, the arm of the first mounting base can include a mount arm that extends into the mount recess and a side arm that extends into the side recess. In some embodiments, the assembly bolt can extend through the mount recess and the mount arm.

In some embodiments, an accessory channel can be formed in the accessory beam. In some embodiments, the assembly bolt can be disposed in the accessory channel when the assembly bolt is coupled with the anchor. In some embodiments, an accessory channel can be formed in a top surface of the accessory beam and be configured to receive a roof-mounted accessory.

Implementations of any of the techniques described above may include a system, a method, a process, a device, and/or an apparatus. The details of one or more implementations are set forth in the accompanying drawings and the description below. Other features will be apparent from the description and drawings, and from the claims.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate the embodiments and, together with the description, further serve to explain the principles and to enable a person skilled in the relevant art(s) to make and use the embodiments. Objects and advantages of illustrative, non-limiting embodiments will become more apparent by describing them in detail with reference to the attached drawings.

FIG. 1 illustrates a perspective view of a cargo platform mounted to a vehicle roof, according to an embodiment.

FIG. 2 illustrates a perspective view of a cargo platform, according to an embodiment.

FIG. 3 illustrates an exploded perspective view of a cargo platform, according to an embodiment.

FIG. 4 illustrates a side view of a cargo platform, according to an embodiment.

FIG. 5 illustrates a front view of a cargo platform, according to an embodiment.

FIG. 6 illustrates a cross-sectional view of a guard rail assembled with a front rail of a cargo platform, according to an embodiment.

FIG. 7 illustrates a cross-sectional view of a guard rail assembled with a side rail of a cargo platform, according to an embodiment.

FIG. 8 illustrates a cross-sectional view of a guard rail assembled with a rear rail of a cargo platform, according to an embodiment.

FIG. 9 illustrates a cross-sectional view of a guard rail assembled with a side rail of a cargo platform, according to an embodiment.

FIG. 10 illustrates a cross-sectional view of an interference between a guard rail and a load bar of a cargo platform, according to an embodiment.

FIG. 11 illustrates an exploded perspective view of a guard rail coupling assembly, according to an embodiment.

FIG. 12 illustrates a cross-sectional view of a guard rail coupling assembly coupled with a side rail of a cargo platform, according to an embodiment.

FIG. 13 illustrates a rear perspective view of a fairing of a cargo platform, according to an embodiment.

FIG. 14 illustrates a schematic cross-sectional view of a fairing assembly for a cargo platform, according to an embodiment.

FIG. 15 illustrates a rear view of a fairing assembly, according to an embodiment.

FIG. 16A illustrates a rear view of part of a fairing assembly, according to an embodiment.

FIG. 16B illustrates a detailed view of the fairing assembly of FIG. 16A, according to an embodiment.

FIG. 17 illustrates a detailed cutaway view of a bumper of a fair assembly, according to an embodiment.

FIG. 18 illustrates a front perspective view of a fairing assembly for a cargo platform, according to an embodiment.

FIG. 19 illustrates a rear perspective view of a fairing assembly for a cargo platform, according to an embodiment.

FIG. 20 illustrates a side view of a cargo platform with an accessory component mounted to an accessory mount, according to an embodiment.

FIG. 21 illustrates a perspective view of an accessory mount, according to an embodiment.

FIG. 22 illustrates a perspective view of a mounting base of an accessory mount, according to an embodiment.

FIG. 23 illustrates a partial perspective view of an accessory beam of an accessory mount, according to an embodiment.

FIG. 24 illustrates a cross-sectional view of an accessory mount coupled to a load bar of a cargo platform, according to an embodiment.

FIG. 25 illustrates a perspective view of a mounting base of an accessory mount, according to an embodiment.

FIG. 26 illustrates a detailed perspective view of an accessory mount, according to an embodiment.

FIG. 27 illustrates a front view of a cargo platform, according to an embodiment.

FIG. 28 illustrates a side view of a cargo platform, according to an embodiment.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., +1%, +2%, +5%, +10%, or +15% of the value).

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

Embodiment 1 of the description—A vehicle mounted roof rack includes a perimeter rail system comprising a front rail, a rear rail, a first side rail, and a second side rail; and a plurality of load bars coupled to the perimeter rail system and disposed within an interior space of the perimeter rail system.

Embodiment 2 of the description—The vehicle mounted roof rack of embodiment 1, wherein the front rail includes a first cross-sectional shape along a midline of the perimeter rail system and the rear rail includes a second cross-sectional shape along the midline of the perimeter rail system, wherein the first cross-sectional shape is different from the second cross-sectional shape.

Embodiment 3 of the description—The vehicle mounted roof rack of embodiment 2, wherein the second cross-sectional shape tapers towards a rear edge of the rear rail.

Embodiment 4 of the description—The vehicle mounted roof rack of embodiment 1, wherein the perimeter rail system further includes a front corner member coupled between the front rail and one of the first side rail and the second side rail, wherein the front corner member includes a top corner surface and a bottom corner surface spaced from and non-parallel to the top corner surface.

Embodiment 5 of the description—The vehicle mounted roof rack of embodiment 1, wherein the perimeter rail system further includes a front corner member coupled between the front rail and one of the first side rail and the second side rail, wherein the front corner member includes a top corner surface, a bottom corner surface spaced apart from the top corner surface, and a low point disposed on the bottom corner surface and spaced a first distance from the top corner surface.

Embodiment 6 of the description—The vehicle mounted roof rack of embodiment 5, wherein the front rail includes a top surface and a bottom surface spaced from the top surface by a second distance, wherein the first distance is greater than the second distance.

Embodiment 7 of the description—The vehicle mounted roof rack of embodiment 6, wherein the top corner surface of the front corner member is coplanar with the top surface of the front rail.

Embodiment 8 of the description—The vehicle mounted roof rack of embodiment 5, wherein at least one of the front rail, the first side rail, and the second side rail include a bottom surface that defines a plane extending along the bottom surface, and wherein the plane intersects the front corner member between the top corner surface and the low point.

Embodiment 9 of the description—A guard rail assembly for a vehicle mounted roof rack includes a guard rail comprising a main body portion and an assembly portion extending from the main body portion, wherein the assembly portion is configured to be disposed in a channel of a rail of the vehicle mounted roof rack.

Embodiment 10 of the description—The guard rail assembly of embodiment 9, wherein the assembly portion of the guard rail includes a tail and an arm extending from the tail, wherein the channel includes a groove formed in a bottom surface of the channel and an elongated notch, and wherein when the guard rail is assembled in the channel, the arm of the assembly portion is configured to be disposed in the elongated notch and the tail is configured to extend into the groove.

Embodiment 11 of the description—The guard rail assembly of embodiment 9, wherein the guard rail is coupled with a first side rail of a perimeter rail system of the vehicle mounted roof rack and a second guard rail is coupled with and a second side rail of the perimeter rail system.

Embodiment 12 of the description—The guard rail assembly of embodiment 11, further including a third guard rail coupled with a front rail and a fourth guard rail coupled with a rear rail of the perimeter rail system.

Embodiment 13 of the description—A vehicle mounted roof rack including a perimeter rail system including a front rail, a rear rail, a first side rail, and a second side rail, wherein a first channel is formed in at least one of the front rail, the rear rail, the first side rail, and the second side rail; a plurality of load bars coupled to the perimeter rail system and disposed within an interior space of the perimeter rail system, wherein a second channel is formed in at least one of the plurality of load bars; and at least one guard rail including a main body portion and an assembly portion extending from the main body portion, wherein the assembly portion is configured to be disposed in the first channel.

Embodiment 14 of the description—The vehicle mounted roof rack of embodiment 13, wherein the first channel has a first depth, the second channel has a second depth, wherein the first depth is greater than the second depth.

Embodiment 15 of the description—The vehicle mounted roof rack of embodiment 14, wherein the assembly portion has a first height, and the first height is less than the first depth and greater than the second depth such that the guard rail cannot be assembled on the plurality of load bars.

Embodiment 16 of the description—A method of assembling a guard rail to a vehicle mounted roof rack, the guard rail including a main body portion and an assembly portion, the vehicle mounted roof rack including a perimeter rail system and a channel formed in a rail of the perimeter rail system, and the method includes the steps of arranging the assembly portion of the guard rail adjacent to the channel formed in the rail of the perimeter rail system; arranging the guard rail at a first angle; inserting a tail of the assembly portion of the guard rail into the channel; rotating the guard rail to a second angle such that an arm extending from the tail of the assembly portion extends into an elongated notch of the channel to couple the guard rail to the vehicle mounted roof rack.

Embodiment 17 of the description—A fairing for a vehicle load rack including a coupling portion configured to couple to the vehicle load rack, and a blade extending from the coupling portion at an oblique angle.

Embodiment 18 of the description—The fairing of embodiment 17, wherein the coupling portion includes a plurality of slots formed in the coupling portion for adjustably coupling the fairing to the vehicle load rack.

Embodiment 19 of the description—The fairing of embodiment 17, wherein the blade includes a body and a bumper coupled to a perimeter of the body.

Embodiment 20 of the description—The fairing of embodiment 19, wherein a plurality of slots are formed along the perimeter of the body of the blade, and wherein the bumper includes an assembly slot and an assembly tab extending into the assembly slot, wherein the assembly tab is configured to engage a slot in the body of the blade to couple the bumper to the body of the blade.

Embodiment 21 of the description—The fairing of embodiment 19, wherein the body of the blade is substantially flat.

Embodiment 22 of the description—The fairing of embodiment 19, wherein a lower edge of the body of the blade is concave.

Embodiment 23 of the description—The fairing of the embodiment 17, wherein a plurality of channels are formed in a forward side of the coupling portion and the blade and configured to stiffen the fairing.

Embodiment 24 of the description—The fairing of embodiment 17, wherein the blade extends at a first angle relative to the coupling portion, wherein the first angle is between about 5 degrees and about 45 degrees.

Embodiment 25 of the description—The fairing of embodiment 24, wherein the first angle is about 25 degrees.

Embodiment 26 of the description—The fairing of embodiment 24, wherein the fairing is configured to rotate relative to the coupling member to adjust the first angle.

Embodiment 27 of the description—An accessory mount configured to couple to a vehicle mounted roof rack having a perimeter rail system and a load bar coupled to the perimeter rail system, the accessory mount includes an accessory beam; a first mounting base disposed at a first end of the accessory beam; and a second mounting base disposed at a second end of the accessory beam, wherein the first and second mounting bases are configured to couple to the load bar and elevate the accessory beam above the load bar and the perimeter rail system.

Embodiment 28 of the description—The accessory mount of embodiment 27, wherein the first mounting base includes a connecting portion including an end wall and an arm extending opposite the end wall and into a recess formed in the accessory beam, and a foot portion extending from the connecting portion and disposed between the accessory beam and the load bar.

Embodiment 29 of the description—The accessory mount of embodiment 28, further including an assembly bolt configured to couple the accessory mount to the load bar, the assembly bolt extending through a first aperture formed in the accessory beam and a second aperture formed in the first mounting base.

Embodiment 30 of the description—The accessory mount of embodiment 29, wherein a channel is formed in the load bar along the length of the load bar, and the assembly bolt couples with an anchor slidably disposed in the channel.

Embodiment 31 of the description—The vehicle mounted roof rack of embodiment 30, wherein the recess of the accessory beam includes a mount recess and a side recess, wherein the arm of the first mounting base includes a mount arm that extends into the mount recess and a side arm that extends into the side recess, and wherein the assembly bolt extends through the mount recess and the mount arm.

Embodiment 32 of the description—The accessory mount of embodiment 31, wherein an accessory channel is formed in the accessory beam, and the assembly bolt is disposed in the accessory channel when the assembly bolt is coupled with the anchor.

Embodiment 33 of the description—The accessory mount of embodiment 27, wherein an accessory channel is formed in a top surface of the accessory beam and configured to receive a roof-mounted accessory.

Embodiments of the cargo platform 100 disclosed herein can be used with, for example, but not limited to, roof top accessories such as bicycle carrier(s), fishing rod carriers, canoe carriers, and/or a cargo container. More specifically, the cargo platform 100 can be roof mounted and offer space for multiple roof top accessories to be mounted to the cargo platform simultaneously.

As discussed above, it is important for roof mounted cargo platforms to have increased versatility so that all types of roof-mounted accessories can be mounted to a vehicle roof at the same time. For example, rigidly mounted guard rails with complicated assemblies can prevent a user from easily moving the guard rails to avoid interference with a long or wide load mounted to the cargo platform. Further, some roof-mounted accessories, such as cargo containers or roof boxes are primarily designed for use with roof mounted bars and not cargo platforms that cover a substantial portion of a vehicle roof. Accordingly, there is a need for accessory mounts that can easily and quickly couple to a cargo platform such that a roof box or cargo carrier can be mounted to a roof mounted cargo platform. In addition, roof mount cargo platforms can affect the air passing over a vehicle roof, causing turbulence and additional wind noise. Further, the turbulence and/or wind noise can be dependent on the size and shape of the vehicle roof, and therefore, it is important that a fairing assembly or wind deflector coupled to the cargo platform can be adjusted to better fit a particular vehicle that the cargo platform is attached to.

Embodiments of load carrier apparatuses, systems, and methods as discussed below can provide balance and variable adjustment for securing loads, variable adjustment of wheel holder positions along the load carrier, adjustable wheel securement arms, and adjustable tilt and vehicle information options for storage and operational configurations.

### Example Cargo Platform System

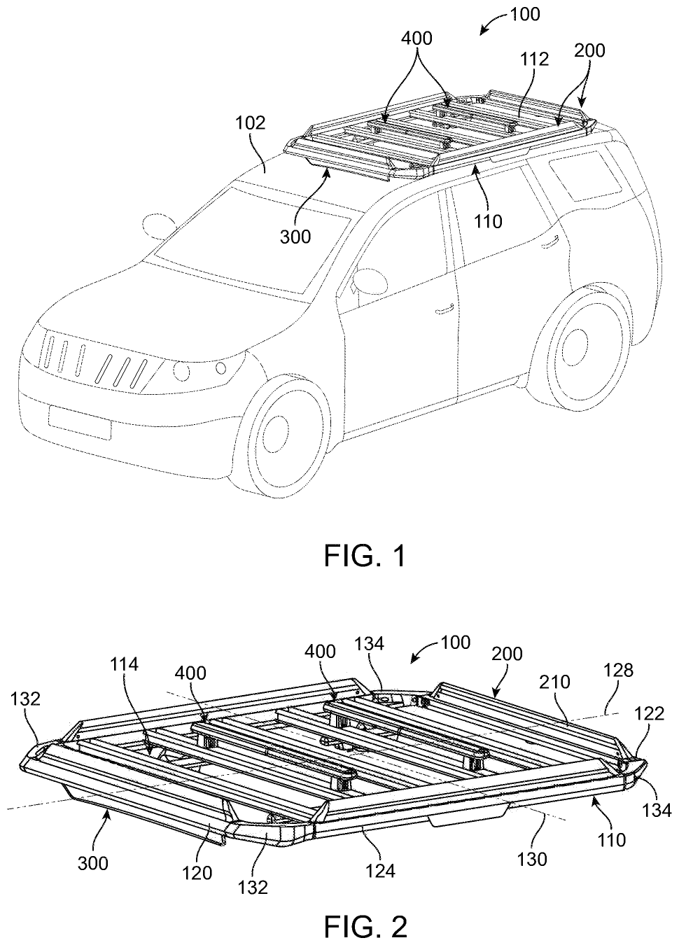

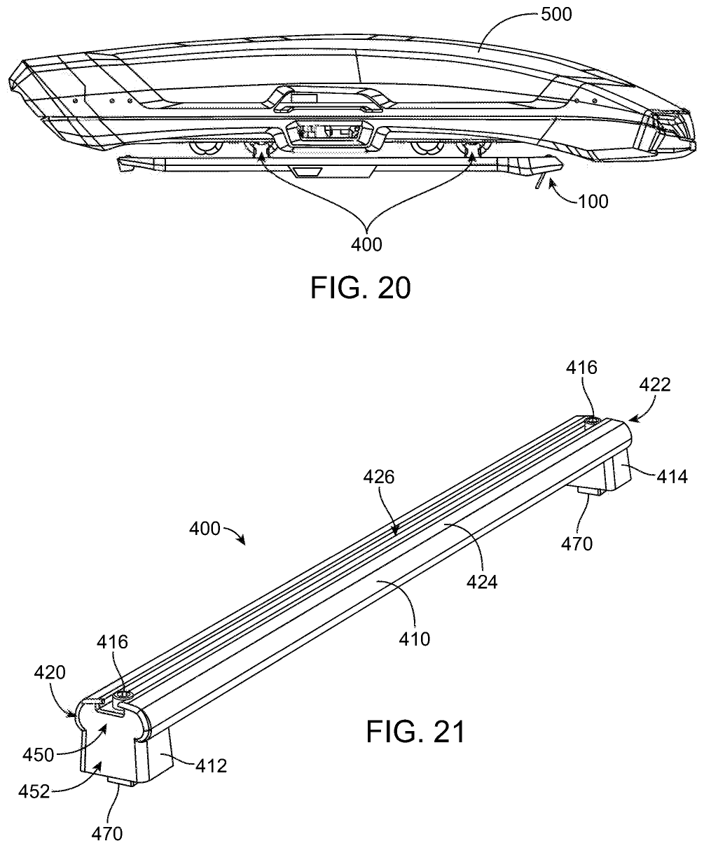

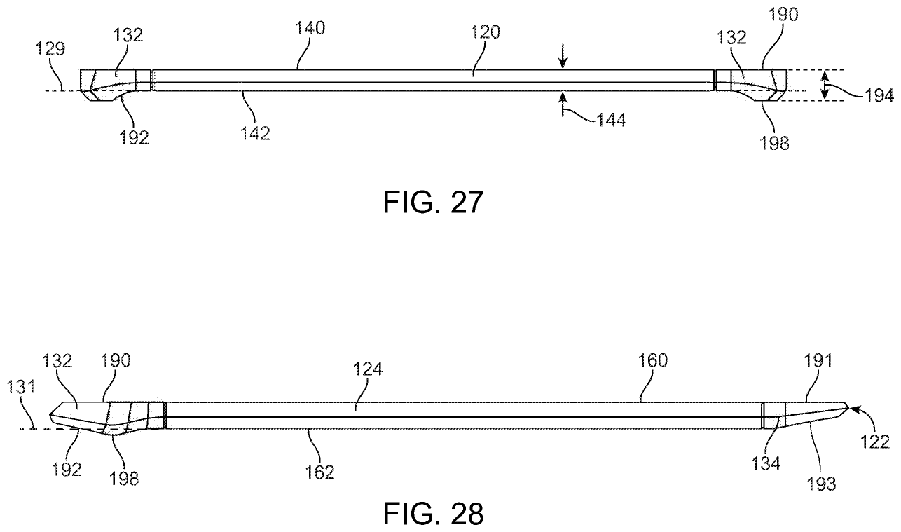

FIGS. 1-5, 27, and 28 illustrate a cargo platform 100, according to embodiments. Cargo platform 100 can be configured to mount to a vehicle roof 102 and secure a load thereto. For example, cargo platform 100 can be configured to secure roof-mounted accessories such as a bicycle rack, a fishing rod carrier, a canoe or boat rack, a ski rack, a cargo container (as shown, for example, in FIG. 20), or any other suitable roof-mounted accessory. In addition, items of luggage can also be mounted directly to cargo platform 100. In some embodiments, a user can secure multiple roof-mounted accessories and/or items of luggage to cargo platform 100. Cargo platform 100 can be used as a stand-alone assembly and/or combined with embodiments of this disclosure, such as, but not limited to guard rail assembly 200, fairing assembly 300, and accessory mount assembly 400.

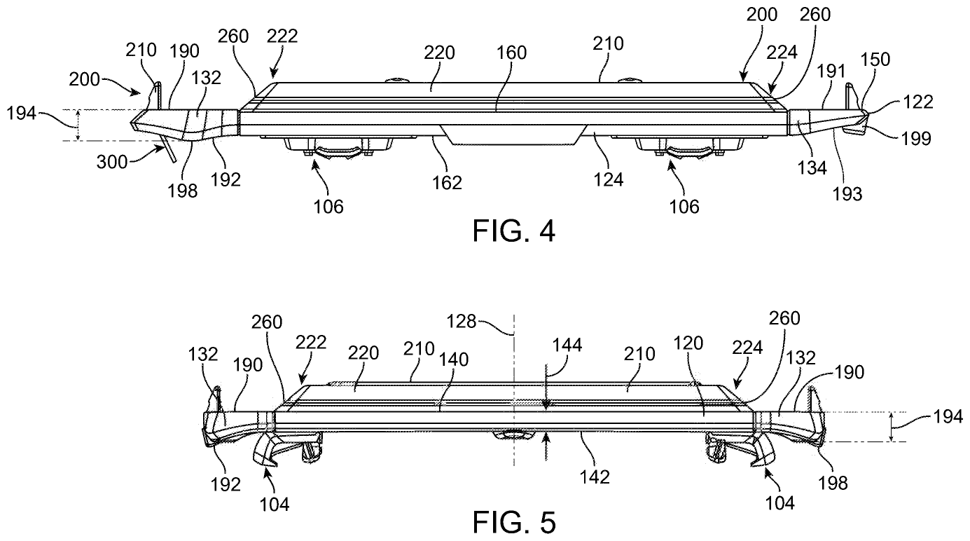

Cargo platform 100 can mount to a vehicle roof 102 and include a perimeter rail system 110 and load bars 112 as shown, for example, in FIGS. 1-3. In some embodiments, cargo platform 100 can couple to roof rails of a vehicle roof 102 via rail coupling members 104 as shown, for example, in FIG. 5. In some embodiments, cargo platform 100 can couple to load beams extending across the width of vehicle roof 102 via load beam coupling members 106 as shown, for example, in FIG. 4. Perimeter rail system 110 extends around a perimeter of cargo platform 100 and forms an interior space 114 within the perimeter rail system 110. Load bars 112 are disposed in interior space 114 and couple to perimeter rail system 110. In the illustrative embodiment shown in FIGS. 1-3, load bars 112 extend across a width of vehicle roof 102. In some embodiments, load bars 112 extend along a length of vehicle roof 102. In the illustrative embodiment shown in FIGS. 2, 3, and 10, channel 116 is formed in a top surface of load bar 112 and configured to couple with a roof-mounted accessory. In some embodiments, accessory mount assembly 400 couples with load bars 112 as will be described in further detail below. In some embodiments, perimeter rail system 110 can be sized to be approximately the same size as vehicle roof 102. In some embodiments, perimeter rail system 110 can extend beyond the edges of vehicle roof 102 to form an overhang. In some embodiments, perimeter rail system 110 can have a smaller footprint than vehicle roof 102.

Perimeter rail system 110 can include a front rail 120, a rear rail 122, a first side rail 124, a second side rail 126, front corner members 132, and rear corner members 134, as shown, for example, in FIGS. 2-5. Front corner members 132 couple between front rail 120 and each of first side rail 124 and second side rail 126. In some embodiments, front corner members 132 are integrally formed with front rail 120, first side rail 124, and second side rail 126. In some embodiments, front corner members 132 are coupled to front rail 120, first side rail 124, and second side rail 126 using bolts, rivets, a bonding material, or other suitable coupling means. Rear corner members 134 couple between rear rail 122 and each of first side rail 124 and second side rail 126. In some embodiments, rear corner members 134 are integrally formed with rear rail 122, first side rail 124, and second side rail 126. In some embodiments, rear corner members 134 are coupled to rear rail 122, first side rail 124, and second side rail 126 using bolts, rivets, a bonding material, or other suitable coupling means. In some embodiments, perimeter rail system 110 is symmetrical across a longitudinal midline axis 128 that extends parallel and equidistant to first and second side rails 124, 126.

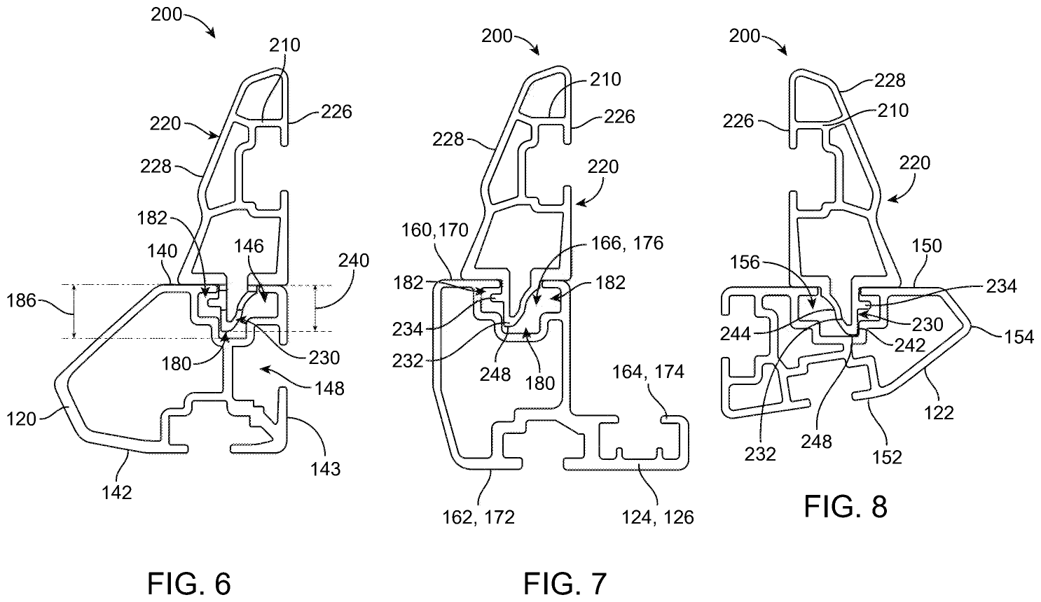

Perimeter rail system 110 can have an aerodynamic shape as it extends from front rail 120 to rear rail 122 as shown, for example, in FIGS. 2-4, 6, 8, and 28. In the illustrative embodiment shown in FIGS. 2-4, perimeter rail system 110 is asymmetrical across a transverse midline axis 130 that extends parallel and equidistant from front and rear rails 120, 122. Front rail 120 includes top surface 140, bottom surface 142, and rear surface 143 and has first cross-sectional shape as shown, for example, in FIG. 6. Rear surface 143 is formed between top and bottom surfaces 140, 142 and faces interior space 114. Bottom surface 142 is spaced apart from top surface 140 by first distance 144. Top channel 146 is formed in top surface 140 and rear channel 148 is formed in rear surface 143. Rear rail 122 includes top surface 150, bottom surface 152, and rear edge 154 and has second cross-sectional shape as shown, for example, in FIG. 8. Top surface 150 and bottom surface 152 taper towards each other as they extend towards rear edge 154. Channel 156 is formed in top surface 150. First side rail 124 and second side rail 126 include top surfaces 160, 170, bottom surfaces 162, 172, and support arms 164, 174 that extend into interior space 114 and are configured to support and couple to load bars 112. First and second side rails 124, 126 are have symmetrical cross-sectional shapes across the longitudinal midline axis 128 as shown, for example, in FIG. 7. In some embodiments, first and second side rails 124, 126 can have an arc shape as they extend parallel to the longitudinal midline axis 128, approximately corresponding to a profile shape of the vehicle roof 102. Channel 166 is formed in top surface 160, and channel 176 is formed in top surface 170. In some embodiments, each of top surfaces 140, 150, 160, 170, are coplanar. Each of the plurality of channels 146, 148, 156, 166, 176 can couple with accessories as shown, for example, in FIGS. 6-8 and 13. For example, the plurality of channels 146, 148, 156, 166, 176 in each of the rails 120, 122, 124, 126 can couple with guard rail assembly 200 and/or fairing assembly 300, as will be described in further detail below. In some embodiments, each of rails 120, 122, 124, 126 can include additional channels on front, rear, bottom, or side surfaces to increase versatility to a user for mounting additional accessories to cargo platform 100 or to secure loads to cargo platform 100. For example, in the illustrative embodiment in FIG. 4, a name plate 199 is coupled to channel formed in bottom surface 152 of rear rail 122.

Rear corner members 134 include top corner surface 191 and bottom corner surface 193 as shown, for example, in FIGS. 2-4 and 28. In some embodiments, top corner surface 191 is substantially coplanar with top surfaces 140, 150, 160, 170 of each of rails 120, 122, 124, 126 to maximize the loading surface of the cargo platform 100. In some embodiments, bottom corner surface 193 can be parallel with bottom surface 152 and taper towards rear edge 154 of rear rail 122. In some embodiments, the resulting projection of bottom corner surface 193 and bottom surface 152 can make cargo platform 100 aerodynamic. Front corner members 132 can include top corner surface 190 and bottom corner surface 192 as shown, for example, in FIGS. 4, 5, 27, and 28. In some embodiments, top corner surface 190 is substantially coplanar with top surfaces 140, 150, 160, 170 of each of rails 120, 122, 124, 126 to maximize the loading surface of cargo platform 100. In some embodiments, bottom corner surface 192 is substantially parallel with top corner surface 190. In the illustrative embodiment shown in FIGS. 4, 5, 27, and 28, bottom corner surface 192 is non-parallel to top corner surface 190 and includes low point 198. In some embodiments, bottom corner surface 192 extends from bottom surface 142 of front rail 120 downward toward low point 198. Bottom corner surface 192 then extends upwardly away from low point 198 toward either bottom surface 162 of first side rail 124, or bottom surface 172 of second side rail 126. In some embodiments, the resulting projections of bottom corner surface 192 can make cargo platform 100 aerodynamic. Low point 198 extends a second distance 194 away from top corner surface 190. In the illustrative embodiment in FIGS. 4 and 5, second distance 194 is greater than first distance 144 such that bottom corner surface 192 of front corner members 132 dip below bottom surfaces 142, 162, 172 of first rail 120 and first and second side rails 124, 126. In some embodiments, the thicker portion of front corner member 132 at low point 198 can provide increased strength of cargo platform 100 while maintaining a co-planar, flat loading surface on the top of cargo platform 100. In some embodiments, bottom surface 142 of front rail 120 defines a front rail plane 129 that extends along bottom surface 142. Front rail plane 129 intersects front corner members 132 between top corner surface 190 and low point 198. In some embodiments, bottom surfaces 162, 172 of first and second side rails 124, 126 can define a side rail plane 131 that extends along bottom surfaces 162, 172. Side rail plane 131 intersects front corner members 132 between top corner surface 190 and low point 198. In some embodiments, low point 198 of front corner member 132 can decrease a distance between vehicle roof 102 and cargo platform 100.

### Example Guard Rail Assembly

FIGS. 2-12 illustrate a guard rail assembly 200, according to embodiments, for use with cargo platform 100. Guard rail assembly 200 can couple to perimeter rail system 110 of cargo platform 100 and be configured to secure items loaded on the cargo platform 100 within the perimeter of the cargo platform 100. Although guard rail assembly 200 can be a stand-alone accessory mounted to cargo platform 100, guard rail assembly 200 can also be used with fairing assembly 300 and/or accessory mount assembly 400.

Guard rail assembly 200 can couple with channels 146, 156, 166, 176 of rails 120, 122, 124, 126 as shown, for example, in FIGS. 2 and 6-8. In the illustrative embodiment shown in FIG. 2, guard rail assembly 200 includes four guard rails 210 coupled to the front rail 120, the rear rail 122, and the first and second side rails 124, 126. In some embodiments, guard rail assembly 200 can include two guard rails assembled to only the first and second side rails 124, 126. In some embodiments, guard rail assembly 200 can include two guard rails 210 assembled to only the front and rear rails 120, 122. In some embodiments, guard rail assembly 200 can include only one guard rail 210 assembled to one of the rails 120, 122, 124, 126. In some embodiments, guard rails 210 can vary in length, such that guard rails 210 assembled to first and second side rails 124, 126 are longer than guard rails 210 assembled to front and rear rails 120, 122.

Guard rail 210 includes main body portion 220 and assembly portion 230 as shown, for example, in FIGS. 6-10. Main body portion 220 extends above the respective coupled to rail 120, 122, 124, 126 and includes first end 222, second end 224, interior wall 226, and exterior wall 228. In the illustrative embodiment shown in FIGS. 6-10, interior wall 226 faces interior space 114 and is substantially vertical. In some embodiments, interior wall 226 can include a channel formed in interior wall 226, such that an accessory of loaded item can be coupled to the guard rail 210. In some embodiments, interior wall 226 is substantially flush with a corresponding interior facing surface of the respective rail 120, 122, 124, 126 that the guard rail 210 is coupled to. Exterior wall 228 faces away from interior space 114. In the illustrative embodiment shown in FIGS. 6-10, exterior wall 228 can be angled such that the coupled end of guard rail 210 is wider than the distal end of guard rail 210. In some embodiments, exterior wall 228 can have a first angled section and a second angled section.

Assembly portion 230 extends away from main body portion 220 and is disposed in a respective channel 146, 156, 166, 176 of the respective rail 120, 122, 124, 126 that the guard rail 210 is coupled with. Each of channels 146, 156, 166, 176 have similar shape and include a groove 180, formed in the bottom surface of the channel, and a notch 182 that extends from the channel (e.g., perpendicularly) and under the respective top surface 140, 150, 160, 170. Accordingly, each channel 146, 156, 166, 176 has a “T” shape under the top surface of the rail. In some embodiments, groove 180 and notch 182 extend the full length of the channel 146, 156, 166, 176. In some embodiments, groove 180 and notch 182 extend a partial length of the channel 146, 156, 166, 176. Groove 180 has a first depth 186 from top surface 140, 150, 160, 170.

Assembly portion 230 extends into channel 146, 156, 166, 176 and includes a tail 232 and an arm 234 as shown, for example in FIGS. 6-8. Tail 232 extends away from main body portion 220 and extends into groove 180. Arm 234 extends outwardly away from tail 232 approximately halfway along the height of tail 232. Arm 234 extends into notch 182. In some embodiments, arm 234 extends perpendicularly away from tail 232. Tail 232 can have a tail height 240. In the illustrative embodiment in FIGS. 6-8, tail height 240 is less than first depth 186 such that the distal end of tail 232 is spaced apart from the bottom of groove 180. In some embodiments, tail height 240 is greater than the depth of other channels formed in components around the cargo platform 100 to prevent the guard rails 210 from being assembled in some positions. For example, in the illustrative embodiment shown in FIG. 10, load bar 112 has channel 116 with second depth 196 that is less than tail height 240 of tail 232. Accordingly, tail 232 interferes with channel 116 and guard rail 210 cannot be assembled to load bar 112.

Assembly portion 230 is shaped such that guard rail 210 can be assembled into channel 146, 156, 166, 176 by rotating guard rail 210. In the illustrative embodiment shown in FIGS. 6-10, tail 232 can have a substantially vertical side 242 and a tapered side 244 such that tail 232 extends to a point at a distal end 248. To assemble guard rail 210 into channel 146, 156, 166, 176, distal end 248 of assembly portion 230 can be arranged adjacent to the opening of the respective channel 146, 156, 166, 176 and guard rail 210 can be rotated at a first angle relative to the top surface 140, 150, 160, 170 such that tapered side 244 is approximately perpendicular to top surface 140, 150, 160, 170. Distal end 248 of tail 232 can then be inserted into channel 146, 156, 166, 176. As the exterior wall 228 approaches top surface 140, 150, 160, 170, guard rail 210 can be rotated such that arm 234 extends into notch 182 and distal end 248 of tail 232 extends into groove 180. In some embodiments, arm 234 extends toward exterior wall 228 and guard rail 210 is rotated into position as described above. In some embodiments, arm 234 extends toward interior wall 226 and guard rail 210 is rotated when interior wall 226 approaches top surface 140, 150, 160, 170.

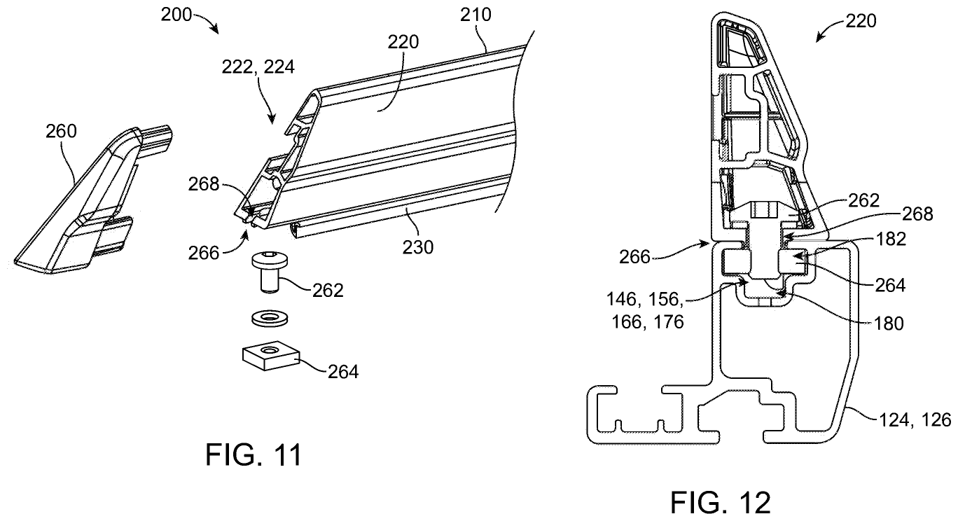

In some embodiments, guard rail 210 can be fixedly coupled to the respective rail 120, 122, 124, 126 via bolt 262 and anchor 264 as shown, for example, in FIGS. 11 and 12.

Assembly portion 230 is spaced apart from first and second ends 222, 224 of main body portion 220 to form coupling ledge 266 at both ends. Each coupling ledge 266 includes a slot 268 that extends from the first or second end 222, 224. Bolt 262 is disposed in the slot 268 such that the head of bolt 262 is in the main body portion 220 and the threaded portion of bolt 262 extends through the coupling ledge 266 and slot 268 and into the channel 146, 156, 166, 176. Anchor 264 is slideably assembled in the channel 146, 156, 166, 176, extending into the notch 182, and couples with bolt 262 to secure the guard rail 210 to the rail 120, 122, 124, 126 of the perimeter rail system 110. End caps 260 can be inserted into the first end 222 and second end 224 to cover the bolt 262 and provide a smooth surface finish of guard rail 210.

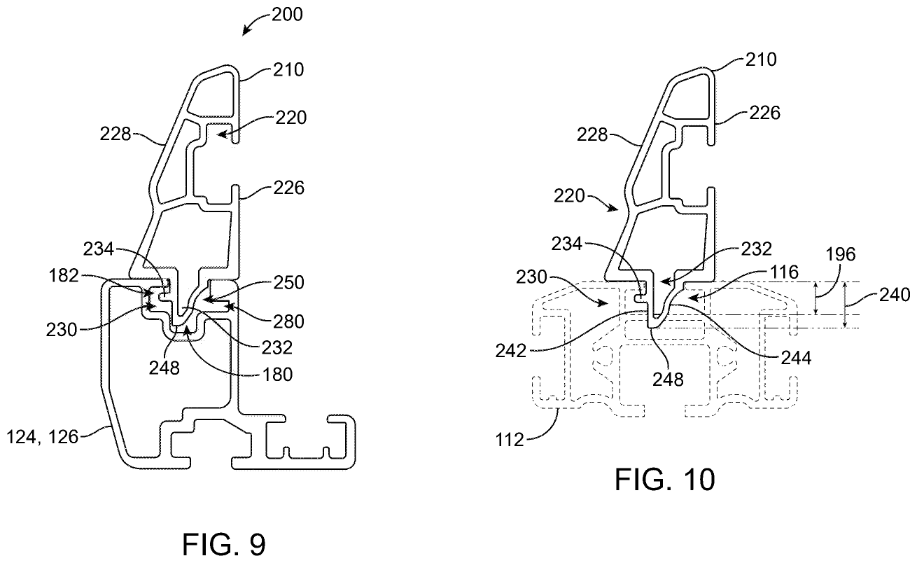

In some embodiments, channel 146, 156, 166, 176 and/or guard rail 210 can include additional features to ensure guard rail 210 is assembled with interior wall 226 facing interior space 114. For example, in the illustrative embodiment shown in FIG. 9, channel 250 includes notch 182 and narrow notch 280 such that arm 234 can extend into notch 182 but interferes with narrow notch 280. In some embodiments, assembly portion 230 of guard rail 210 is positioned closer to interior wall 226 than exterior wall 228 and channel 146, 156, 166, 176 is positioned closer to the interior space such that when guard rail 210 is assembled correctly, interior wall 226 is substantially flush with a corresponding interior facing surface of the respective rail 120, 122, 124, 126. When guard rail 210 is assembled incorrectly, exterior wall 228 overhangs the interior facing surface of the respective rail 120, 122, 124, 126.

Example Fairing assembly

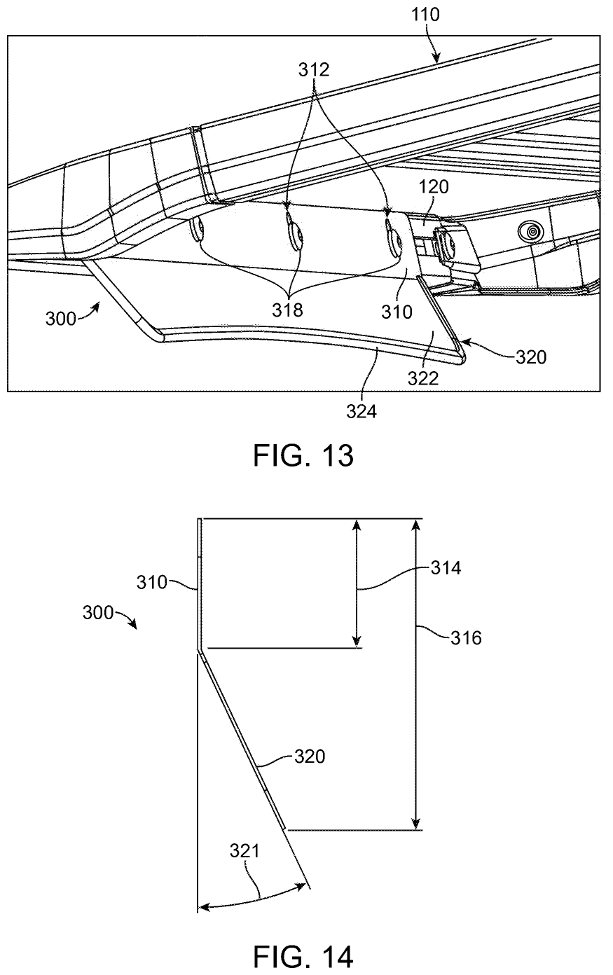

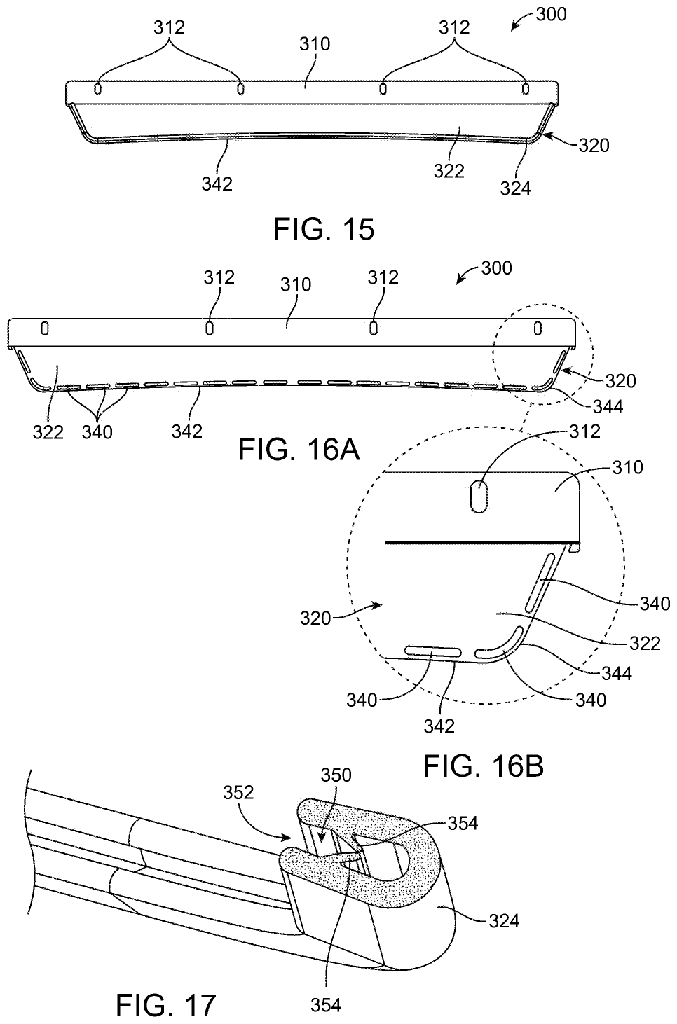

FIGS. 13-19 illustrate fairing assembly 300 for use with cargo platform 100, according to an embodiment. Fairing assembly 300 can be configured to extend into a space between cargo platform 100 and the vehicle roof 102 that the cargo platform 100 is mounted to. Fairing assembly 300 can be configured to reduce wind noise travelling over the vehicle roof 102. Although fairing assembly 300 can be a stand-alone accessory mounted to cargo platform 100, fairing assembly 300 can also be used with guard rail assembly 200 and accessory mount assembly 400.

Fairing assembly 300 can couple with perimeter rail system 110 and be configured to deflect or redirect air traveling over vehicle roof 102 and between the vehicle roof 102 and the cargo platform 100. In the illustrative embodiment shown in FIGS. 2 and 13, fairing assembly 300 can be slideably coupled to rear surface 143 of front rail 120. In some embodiments, fairing assembly can be coupled to rear rail 122, first side rail 124, and/or second side rail 126. Fairing assembly 300 can include coupling portion 310 and blade 320 as shown, for example, in FIGS. 13-15. Coupling portion 310 can include a plurality of slots 312 formed along the width of the coupling portion 310 and extending vertically through the coupling portion 310. In the illustrative embodiment shown in FIG. 13, assembly bolts 318 extend through the slots 312 and are secured, for example, with anchors (not shown) that are disposed in rear channel 148 of front rail 120. Fairing assembly 300 can be adjustably coupled to the front rail 120 such that the distance that fairing assembly 300 extends into the space between the cargo platform 100 and vehicle roof 102 can be adjusted by sliding coupling portion 310 along slots 312. In some embodiments, slots 312 can have a length between about 10 mm and about 20 mm. In some embodiments, coupling portion 310 can have a first height 314 between about 20 mm and about 60 mm. In some embodiments, coupling portion 310 can have a first height 314 between about 35 mm and about 50 mm. In some embodiments, coupling portion 310 can have a first height 314 of approximately 43.8 mm. In some embodiments, fairing assembly 300 can have a total height 316 of between about 80 mm and about 150 mm. In some embodiments, fairing assembly 300 can have a total height 316 of between about 95 mm and about 115 mm. In some embodiments, fairing assembly 300 can have a total height 316 of approximately 105 mm. In some embodiments, slots 312 can be round apertures such that fairing assembly 300 cannot be adjustably coupled to the perimeter rail system 110.

In the illustrative embodiment shown in FIGS. 13 and 14, blade 320 extends away and rearward from coupling portion 310 at a first angle 321. In some embodiments, first angle 321 can be about 25 degrees. In some embodiments, first angle 321 can be between about 5 degrees and about 45 degrees. In some embodiments, first angle 321 can be adjustable such that blade 320 and be tilted relative to coupling portion 310 to best fit the vehicle roof 102 that the cargo platform 100 is mounted to. In some embodiments, blade 320 can extend substantially parallel with coupling portion with vertical orientation. In some embodiments, blade 320 can extend forward of coupling portion 310.

In some embodiments, blade 320 extends away from coupling portion 310, towards vehicle roof 102, and includes a body 322 and a bumper 324 as shown, for example, in FIGS. 13-17. Body 322 can include a plurality of slots 340 formed in body 322 and extending along a perimeter edge 344 of body 322 as shown, for example, in FIGS. 16A and 16B. The plurality of slots 340 can be configured to assemble with bumper 324. Body 322 can have a concave shaped lower edge 342 to correspond to profile of a vehicle roof 102. In some embodiments, concaved lower edge 342 can help maintain an approximately constant gap between lower edge 342 of fairing assembly 300 and vehicle roof 102. In some embodiments, concaved lower edge 342 can maintain contact with vehicle roof 102 along all or most of the length of lower edge 342. In some embodiments, lower edge 342 can have a different shape such as being straight, convex, or undulating. In the illustrative embodiment shown in FIGS. 13-16, body 322 is a substantially flat plate and made from metal.

In some embodiments, bumper 324 can be coupled to the perimeter edge 344 of body 322 and configured to protect a user or vehicle roof 102 from any sharp edges of body 322. In some embodiments, bumper 324 can be integrally formed and/or extruded with body 322. In some embodiments, bumper 324 is a soft, deformable material such as rubber, polymer, foam, or other similar materials. As shown in the illustrative embodiment shown in FIG. 17, bumper 324 can include an assembly slot 350 formed in bumper 324 and configured to accommodate the perimeter edge 344 of body 322. Bumper 324 can include a plurality of assembly tabs 354 that extend into assembly slot 350 and away from opening 352 of slot 350. Assembly tabs 354 can be configured to extend into and couple with the plurality of slots 340 formed in the perimeter edge 344 of body 322. Assembly tabs 354 can extend a discrete distance along the length of bumper 324 that corresponds to the length of the respective slots 312 in body 322.

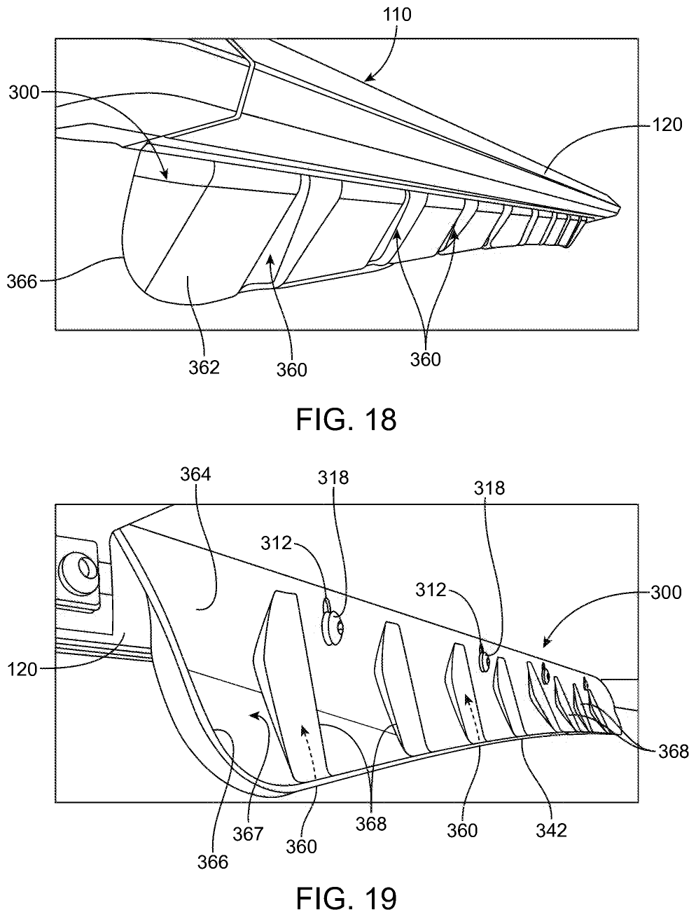

In the illustrative embodiment shown in FIGS. 18 and 19, fairing assembly 300 can include a plurality of channels 360 formed along the width of fairing assembly 300 and extending vertically downward from the coupling portion 310 to the blade 320. The plurality of channels 360 can be configured to increase the stiffness of fairing assembly 300 such that fairing assembly 300 can resist deflection from air travelling over vehicle roof 102. The plurality of channels 360 can be formed in a front surface 362 of fairing assembly 300 and extend rearward forming a stepped profile along the width of fairing assembly 300. The plurality of channels 360 can form protrusions 368 on a rear surface 364 of fairing assembly 300. Fairing assembly 300 can include a perimeter lip 366 extending away from front surface 362 to form an open pocket 367 in the rear surface 364. Perimeter lip 366 can be formed with a large radius to remove sharp edges from the perimeter edge of body 322. In some embodiments, bumper 324 can be coupled to perimeter lip 366.

### Example Accessory Mount Assembly

FIGS. 20-26 illustrate accessory mount assembly 400 for use with cargo platform 100, according to an embodiment. Accessory mount assembly 400 can be configured to mount to load bars 112 of cargo platform 100 and provide an elevated mounting surface above cargo platform 100. In some embodiments, accessory mount assembly 400 can be configured to receive a roof-mounted accessory 500 such that the roof-mounted accessory 500 is spaced apart from the cargo platform 100. Although accessory mount assembly 400 can be a stand-alone accessory mounted to cargo platform 100, accessory mount assembly 400 can also be used with guard rail assembly 200 and fairing assembly 300.

Accessory mount assembly 400 can mount to load bars 112 and include, for example, accessory beam 410, first mounting base 412, second mounting base 414, and accessory bolt 416 as shown, for example, in FIGS. 20-24. First mounting base 412 and second mounting base 414 can be configured to support accessory beam 410 in an elevated position above cargo platform 100. In some embodiments, accessory mount assembly 400 can be configured to position roof-mounted accessory 500 in an elevated position above cargo platform 100 and above guard rail assembly 200. Accessory beam 410 can include first end 420, second end 422 opposite first end 420, and top surface 424 spanning between first end 420 and second end 422. Accessory channel 426 can be formed in top surface 424 between first end 420 and second end 422 and configured to receive and couple with roof-mounted accessory 500. In some embodiments, accessory channel 426 can be substantially similar to channel 116 formed in load bars 112. A first aperture 430 can be formed in a bottom surface of accessory channel 426 and disposed at first end 420 and second end 422 of accessory beam 410. In some embodiments, bolt head opening 432 can be formed through top surface 424 and into accessory channel 426 and disposed at first end 420 and second end 422 of accessory beam 410. First aperture 430 and bolt head opening 432 can be configured to receive accessory bolt 416 such that when accessory bolt 416 is inserted through first aperture 430, the bolt head of accessory bolt 416 is disposed within accessory channel 426.

In some embodiments, accessory beam 410 can be extruded and form recesses 428 through accessory beam 410 as shown, for example, in FIG. 23. Recesses 428 can be configured to accommodate corresponding arms 458 in first and second mounting bases 412, 414. In the illustrative embodiment shown in FIGS. 23 and 24, recess 428 can include mount recess 440 and side recesses 442. Mount recess 440 can be positioned beneath accessory channel 426 such that first aperture 430 can extend between accessory channel 426 and into mount recess 440 and accessory bolt 416 can extend through mount recess 440. Side recesses 442 can be positioned adjacent to mount recess 440 on forward and rearward portions of accessory beam 410. In the illustrative embodiment shown in FIG. 24, bolt head opening 432 can be formed through top surface 424 and a bottom surface of accessory channel 426 such that the head of accessory bolt 416 can be disposed in mount recess 440 when accessory mount accessory 400 is coupled with cargo platform 100.

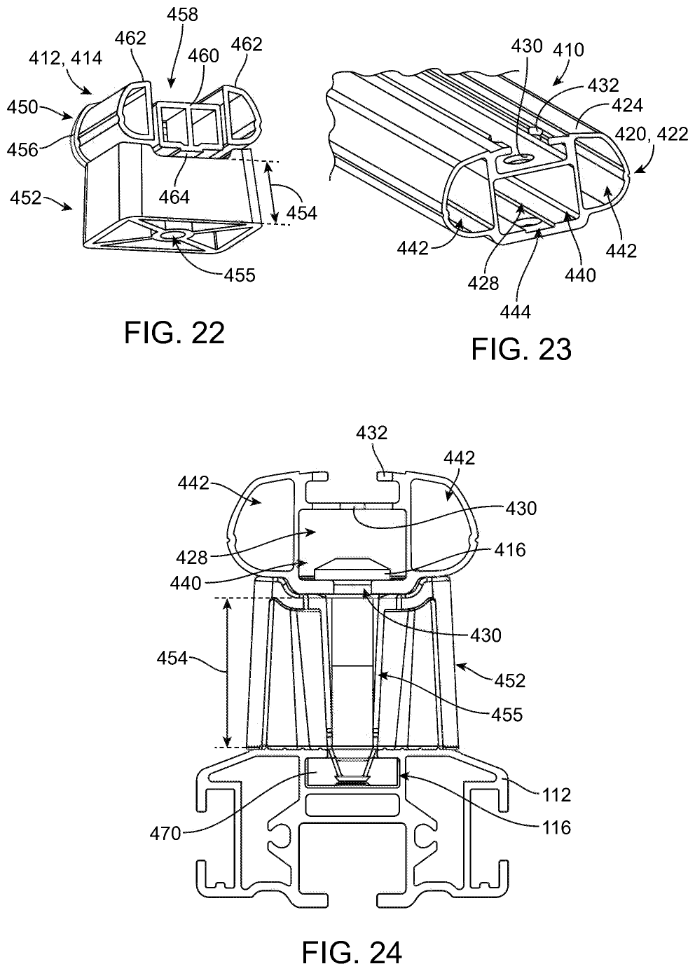

First mounting base 412 can be coupled to first end 420 of accessory beam 410. Second mounting base 414 can be coupled to second end 422 of accessory beam 410 and is substantially similar to first mounting base 412. First mounting base 412 can include connecting portion 450 and foot portion 452 as shown, for example, in FIG. 22. Connecting portion 450 can be configured to be inserted into recess 428 and couple to first end 420 of accessory beam 410. Connecting portion 450 can include end wall 456 and arm 458 extending away from end wall 456. In some embodiments, end wall 456 has an exterior surface that is substantially flat and flush with an exterior wall of foot portion 452 as shown, for example, in FIG. 21. In the illustrative embodiment shown in FIG. 22, arm 458 includes a mount arm 460 and side arms 462. Mount arm 460 can be configured to be inserted into mount recess 440, and side arms 462 can be configured to be inserted into respective side recesses 442. In some embodiments, mount arm 460 can include a protrusion 464 extending from a bottom surface of mount arm 460, and mount recess 440 can include notch 444 formed in a bottom surface of mount recess 440 that corresponds with protrusion 464. Foot portion 452 can be disposed between accessory beam 410 and load bar 112 and configured to support and elevate accessory beam 410 above load bar 112. In some embodiments, foot portion 452 can have foot height 454 between about 10 mm and about 80 mm. Foot portion 452 can be integrally formed with connecting portion 450 such that first mounting base is a single component. Foot portion 452 can have an approximately rectangular cross-sectional shape. In some embodiments, foot portion 452 can be hollow and include a plurality of support members to provide stiffness. Second aperture 455 is formed through mount arm 460 and foot portion 452 and configured to receive accessory bolt 416.

In some embodiments, accessory mount assembly 400 includes three components and two assembly bolts to couple with load bar 112 and provide an elevated load surface for roof-mounted accessory 500 to be mounted above cargo platform 100. The reduced number of components allows for simple assembly by a user and less packaging for transportation. To assemble accessory mount assembly 400 to load bar 112, arms 458 of first and second mounting bases 412, 414 are inserted into respective recesses 428 in first and second ends 420, 422 of accessory beam 410. First and second mounting bases can be arranged on load bar 112 in the desired position of the user. Anchors 470 can be slideably disposed in channel 116 of load bar 112 and aligned with first and second mounting bases 412, 414. Accessory bolt 416 can then be inserted through first aperture 430 and mount recess 440 in accessory beam 410 and through second aperture 455 in first mounting base 412 and engage anchor 470 to couple accessory mount assembly 400 to load bar 112 of cargo platform 100.

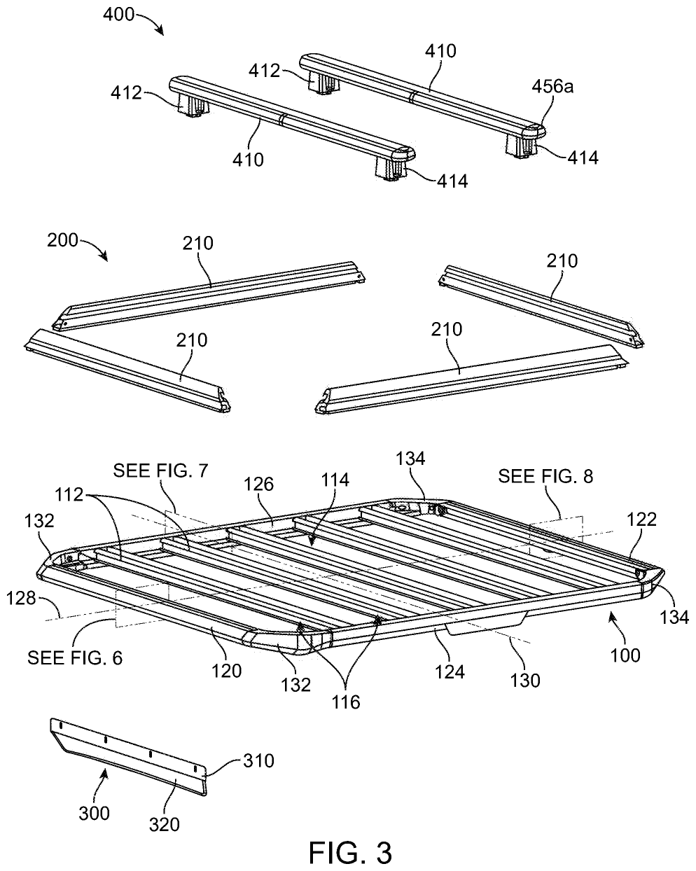

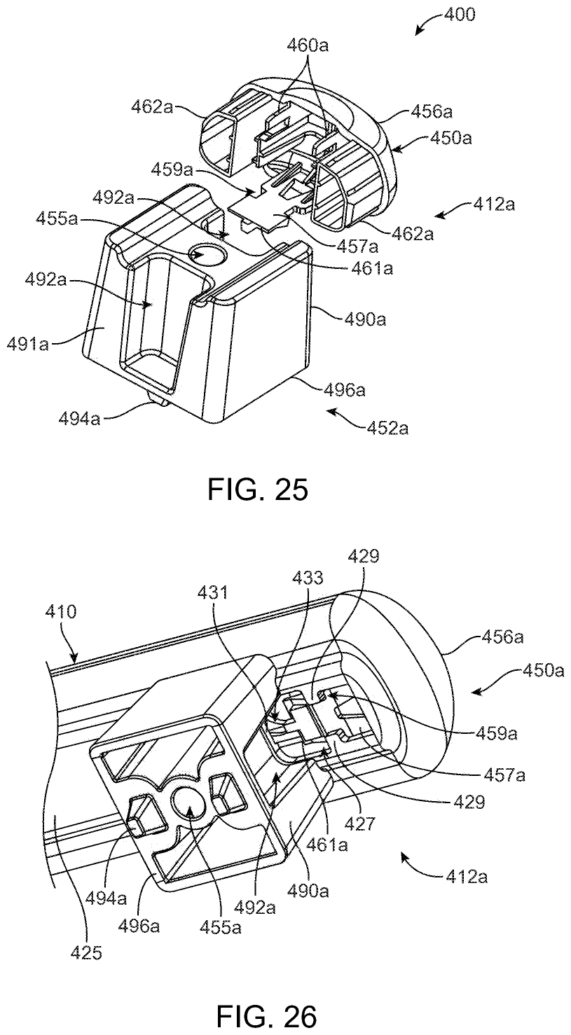

In some embodiments, accessory mount assembly 400 can include first mounting base 412a that couples with first end 420 of accessory beam 410 as shown, for example, in FIGS. 25 and 26. First mounting base 412a can include connecting portion 450a and foot portion 452a. In the illustrative embodiment shown in FIGS. 25 and 26, connecting portion 450a and foot portion 452a are separate components. In some embodiments, connecting portion 450a can couple with accessory beam 410 and other accessory components mounted to vehicle roof 102. Connecting portion 450a can be configured to be inserted into recess 428 and couple to first end 420 of accessory beam 410. Connecting portion 450a can include end cap 456a, arm 458a, and coupling member 457a extending away from end cap 456a and configured to couple to bottom surface 425 of accessory beam 410. In some embodiments, end cap 456a has a convex shape and overhangs an exterior wall of foot portion 452a as shown, for example, in FIGS. 3 and 26. In the illustrative embodiment shown in FIG. 25, arm 458a includes a mount walls 460a and side arms 462a. Mount walls 460a can be configured to be inserted into mount recess 440, and side arms 462a can be configured to be inserted into respective side recesses 442.

In some embodiments, coupling member 457a is a cantilever beam and extends away from end cap 456a and through assembly aperture 27 formed in bottom surface 425 of accessory beam 410. In some embodiments, coupling member 457a is approximately flush with bottom surface 425. In some embodiments, engagement arms 429 are coupled with bottom surface 425 and extend into assembly aperture 427. Engagement arms 429 can couple with engagement recesses 459a formed in coupling member 457a as shown, for example, FIG. 26. Coupling member 457a can be configured to deflect or bend outwardly away from bottom surface 425 of accessory beam 410 such that engagement recesses 459a of coupling member 457a disengage and decouple from engagement arms 429. In the illustrative embodiment shown in FIG. 26, a first end 431 of assembly aperture 427 is spaced apart from free end 461a of coupling member 457a to form finger space 433 between free end 461a and first end 431. Finger space 433 is sized to allow a user to insert their finger into finger space 433 and pull coupling member 457a away from bottom surface 425 of accessory beam 410 to disengage coupling member 457a from engagement arms 429.

Foot portion 452a can be disposed between accessory beam 410 and load bar 112 and configured to support and elevate accessory beam 410 above load bar 112. Foot portion 452 can be separate from connecting portion 450a such that foot portion can be positioned further inboard of first end 420. In some embodiments, first aperture 430 can be a slot such that foot portion can couple in a plurality of positions along the length of accessory beam 410. Foot portion 452a can include first side 490a, second side 491a, positioning arms 494a, and assembly recesses 492a formed in each of first and second sides 490a, 491a as shown, for example. In FIGS. 25 and 26. Assembly recesses 492a extend inwardly into first and second sides 490a, 491a of foot portion 452a. Assembly recesses 492a can be formed in both first and second sides 490a, 491a such that foot portion 452a can be mounted with first side 490a adjacent to first end 420 or second side 491a adjacent to first end 420. Second aperture 455a is formed through foot portion 452a between assembly recesses 492a and configured to receive accessory bolt 416. Assembly recesses 492a are sized to be approximately flush with assembly aperture 427 of accessory beam 410 such that access to finger space 433 is maintained when accessory beam 410 is coupled to foot portion 452a. In some embodiments, assembly recesses 492a can advantageously allow for foot portion 452a to be disposed closer to first end 420 of accessory beam 410 while maintaining access to finger space 433. Positioning arms 494a extend away from a bottom surface 496a of foot portion 452a and are configured to extend into channel 116 of load bar 112 to position and align aperture 455a adjacent to channel 116 such that accessory bolt 416 can more easily locate in channel 116 during assembly.

It is to be appreciated that the Detailed Description section, and not the Brief Summary and Abstract sections, is intended to be used to interpret the claims. The Summary and Abstract sections may set forth one or more but not all embodiments of the load carrier system and apparatus, and thus, are not intended to limit the present embodiments and the appended claims.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1. A vehicle mounted roof rack, comprising:
a perimeter rail system comprising a front rail, a rear rail, a first side rail, and a second side rail; and
a plurality of load bars coupled to the perimeter rail system and disposed within an interior space of the perimeter rail system.

2. The vehicle mounted roof rack of claim 1, wherein the front rail comprises a first cross-sectional shape along a midline of the perimeter rail system and the rear rail comprises a second cross-sectional shape along the midline of the perimeter rail system, wherein the first cross-sectional shape is different from the second cross-sectional shape.

3. The vehicle mounted roof rack of claim 2, wherein the second cross-sectional shape tapers towards a rear edge of the rear rail.

4. The vehicle mounted roof rack of claim 1, wherein the perimeter rail system further comprises a front corner member coupled between the front rail and one of the first side rail and the second side rail,
wherein the front corner member comprises a top corner surface and a bottom corner surface spaced from and non-parallel to the top corner surface.

5. The vehicle mounted roof rack of claim 1, wherein the perimeter rail system further comprises a front corner member coupled between the front rail and one of the first side rail and the second side rail,
wherein the front corner member comprises a top corner surface, a bottom corner surface spaced apart from the top corner surface, and a low point disposed on the bottom corner surface and spaced a first distance from the top corner surface.

6. The vehicle mounted roof rack of claim 5, wherein the front rail comprises a top surface and a bottom surface spaced from the top surface by a second distance, wherein the first distance is greater than the second distance.

7. The vehicle mounted roof rack of claim 6, wherein the top corner surface of the front corner member is coplanar with the top surface of the front rail.

8. The vehicle mounted roof rack of claim 5, wherein at least one of the front rail, the first side rail, and the second side rail comprise a bottom surface that defines a plane extending along the bottom surface, and wherein the plane intersects the front corner member between the top corner surface and the low point.

9.-16. (canceled)

17. A fairing for a vehicle load rack, the fairing comprising:
a coupling portion configured to couple to the vehicle load rack; and
a blade extending from the coupling portion at an oblique angle.

18. The fairing of claim 17, wherein the coupling portion comprises a plurality of slots formed in the coupling portion for adjustably coupling the fairing to the vehicle load rack.

19. The fairing of claim 17, wherein the blade comprises a body and a bumper coupled to a perimeter of the body.

20. The fairing of claim 19, wherein a plurality of slots are formed along the perimeter of the body of the blade, and
wherein the bumper comprises an assembly slot and an assembly tab extending into the assembly slot, wherein the assembly tab is configured to engage a slot in the body of the blade to couple the bumper to the body of the blade.

21. The fairing of claim 19, wherein the body of the blade is substantially flat.

22. The fairing of claim 19, wherein a lower edge of the body of the blade is concave.

23. The fairing of the claim 17, wherein a plurality of channels are formed in a forward side of the coupling portion and the blade and configured to stiffen the fairing.

24. The fairing of claim 17, wherein the blade extends at a first angle relative to the coupling portion, wherein the first angle is between about 5 degrees and about 45 degrees.

25. The fairing of claim 24, wherein the first angle is about 25 degrees.

26. The fairing of claim 24, wherein the fairing is configured to rotate relative to the coupling member to adjust the first angle.

27.-33. (canceled)

34. The vehicle mounted roof rack of claim 1, further comprising a fairing coupled with the perimeter rail system and extending into a space between the perimeter rail system and a vehicle roof.
